(19) United States
(12) Patent Application Publication
(10) Pub. No.: US 2021/0191181 A1
(43) Pub. Date: Jun. 24, 2021

(54) ARRAY SUBSTRATE, FABRICATION METHOD THEREOF AND DISPLAY DEVICE

(71) Applicant: BOE Technology Group Co., Ltd., Beijing (CN)

(72) Inventors: Yunsik IM, Beijing (CN); Hui ZHANG, Beijing (CN); Yue JIA, Beijing (CN)

(21) Appl. No.: 17/038,169

(22) Filed: Sep. 30, 2020

(30) Foreign Application Priority Data
Dec. 18, 2019 (CN) 201911311523.7

(51) Int. Cl. G02F 1/1343; G02F 1/1333; G02F 1/1362; H01L 27/12

(52) U.S. Cl. CPC G02F 1/13439; G02F 1/134309; G02F 1/133345; G02F 2001/136218; H01L 27/1259; G02F 2201/123; G02F 1/136209

(57) ABSTRACT

The present application provides an array substrate, a method for fabricating the array substrate, and a display device. The method for fabricating the array substrate includes: forming a plurality of light-shielding electrode structures spaced apart from each other on a substrate; forming an insulating film on a side of the substrate close to the light-shielding electrode structures, the insulating film covering the plurality of light-shielding electrode structures and the substrate; and forming insulating barriers between adjacent light-shielding electrode structures by performing exposure from a side of the substrate away from the light-shielding electrode structures.

### CROSS REFERENCE TO RELATED APPLICATIONS

The present application claims priority to Chinese patent application No. 201911311523.7, filed on Dec. 18, 2019 to the National Intellectual Property Administration, PRC, the entire contents of which are incorporated herein by reference.

### TECHNICAL FIELD

The application belongs to the field of display technology, and particularly relates to an array substrate, a fabrication method of the array substrate and a display device.

### BACKGROUND

With the development of thin film field effect transistor liquid crystal display (TFT-LCD Display) technology and the advancement of industrial technology, liquid crystal displays with high resolution (PPI) are becoming more popular.

With the development of liquid crystal displays with high resolution (PPI), a distance between pixels in a display becomes smaller, and has already been substantially smaller than 1 μm. In this case, electric fields generated between pixels may interfere with each other and thus a phenomenon of display crosstalk occurs, which is one of the biggest obstacles to achieving high-resolution display. In order to prevent this phenomenon, an insulating wall for reducing electric field interference needs to be formed between pixels.

In general, the insulating wall is formed by a nano-imprint lithography process, which must have a capability of accurate alignment with high resolution, otherwise, the formed insulating wall may overlap with an edge of a pixel to cause a loss of the display aperture ratio of the display.

### SUMMARY

In one aspect, an embodiment of the present disclosure provides a method for fabricating an array substrate, including steps of: forming a plurality of light-shielding electrode structures spaced apart from each other on a substrate; forming an insulating film on a side of the substrate close to the light-shielding electrode structures, the insulating film covering the plurality of light-shielding electrode structures and the substrate; and forming insulating barriers between adjacent light-shielding electrode structures by performing exposure from a side of the substrate away from the light-shielding electrode structures.

In some embodiments, each of the light-shielding electrode structures includes a light-transmissive pixel electrode and a light-shielding pattern, and an orthographic projection of the light-shielding pattern on the substrate completely coincides with an orthographic projection of the pixel electrode on the substrate.

In some embodiments, the method for fabricating an array substrate further includes: after the step of forming the insulating barriers, removing the light-shielding pattern.

In some embodiments, the light-shielding pattern and the pixel electrode are formed simultaneously.

In some embodiments, each of the light-shielding electrode structures includes a pixel electrode that is opaque to light.

In some embodiments, the light-shielding pattern is made of a light-shielding metal material.

In some embodiments, the insulating film includes brominated polystyrene or a photoresist, and the step of forming the insulating barriers includes: exposing the insulating film from the side of the substrate away from the light-shielding electrode structures; and developing the exposed insulating film to form the insulating barriers.

In some embodiments, the insulating film includes silicon nitride or silicon oxide, and the step of forming the insulating barriers includes: forming a photoresist layer on a side of the insulating film away from the substrate; exposing the photoresist layer from the side of the substrate away from the light-shielding electrode structures; developing the exposed photoresist layer to form a photoresist pattern; and etching the insulating film by using the photoresist pattern as an etching mask to form the insulating barriers.

In some embodiments, the light-transmissive pixel electrode includes crystalline indium tin oxide, the step of forming the plurality of light-shielding electrode structures includes forming the light-transmissive pixel electrodes, and the forming of the light-transmissive pixel electrodes includes: forming a pixel electrode film of amorphous indium tin oxide on the substrate by deposition; patterning the pixel electrode film to form the pixel electrodes spaced apart from each other; and annealing the pixel electrodes to convert the amorphous indium tin oxide into the crystalline indium tin oxide.

In some embodiments, the light-shielding pattern is made of any one of aluminum, copper, or molybdenum.

In another aspect, an embodiment of the present disclosure provides an array substrate fabricated by the above method, including: a substrate; and pixel electrodes and insulating barriers on the substrate, the pixel electrodes being spaced apart from each other, the insulating barriers each being between adjacent ones of the pixel electrodes.

In some embodiments, a pitch of the adjacent pixel electrodes is less than 1 μm.

In some embodiments, a distance between the substrate and a surface of each of the insulating barriers away from the substrate is greater than a distance between the substrate and a surface of each of the pixel electrodes away from the substrate.

In some embodiments, a cross section of each of the insulating barriers taken along a plane perpendicular to the substrate has a shape of inverted trapezoid.

In another aspect, an embodiment of the present disclosure provides a display device including the above array substrate.

In another aspect, an embodiment of the present disclosure provides an array substrate, including: a substrate; pixel electrodes and insulating barriers on the substrate, the pixel electrodes being spaced apart from each other, the insulating barriers each being between adjacent ones of the pixel electrodes, where a cross section of each of the insulating barriers taken along a plane perpendicular to the substrate has a shape of inverted trapezoid.

### BRIEF DESCRIPTION OF DRAWINGS

FIG. 1 is a schematic diagram illustrating display crosstalk of adjacent pixels in a liquid crystal cell without an insulating barrier;

FIG. 2 is a schematic diagram illustrating a case where no display crosstalk occurs on adjacent pixels in a liquid crystal cell with an insulating barrier;

FIG. 3 is a schematic diagram of a process for forming insulating barriers by nano-imprint lithography;

FIG. 4 is a cross-sectional view of an array substrate in which an insulating barrier formed by nano-imprint lithography overlaps with an edge of a pixel;

FIG. 5 is a cross-sectional view of a liquid crystal cell in which an insulating barrier formed by nano-imprint lithography overlaps with an edge of a pixel;

FIG. 6 is a schematic diagram illustrating processes of a method for fabricating an array substrate according to an embodiment of the present disclosure;

FIG. 7 is a cross-sectional view of an array substrate fabricated by the fabricating processes of FIG. 6;

FIG. 8 is a schematic diagram illustrating processes of a method for fabricating an array substrate according to an embodiment of the present disclosure;

FIG. 9 is a schematic diagram illustrating processes of a method for fabricating an array substrate according to an embodiment of the present disclosure; and

FIG. 10 is a cross-sectional view of a display device according to an embodiment of the present disclosure.

### DETAILED DESCRIPTION

In order to make those skilled in the art better understand the technical solution of the present disclosure, an array substrate, a method for fabricating the same, and a display device of the present disclosure are described in detail below with reference to the accompanying drawings and the detailed description.

As shown in FIG. 1, in a case where no insulating barrier is disposed between pixels, electric fields generated between pixels may interfere with each other and thus a phenomenon of display crosstalk occurs. For example, light leakage may occur on an OFF pixel under the influence of the electric field of an adjacent ON pixel.

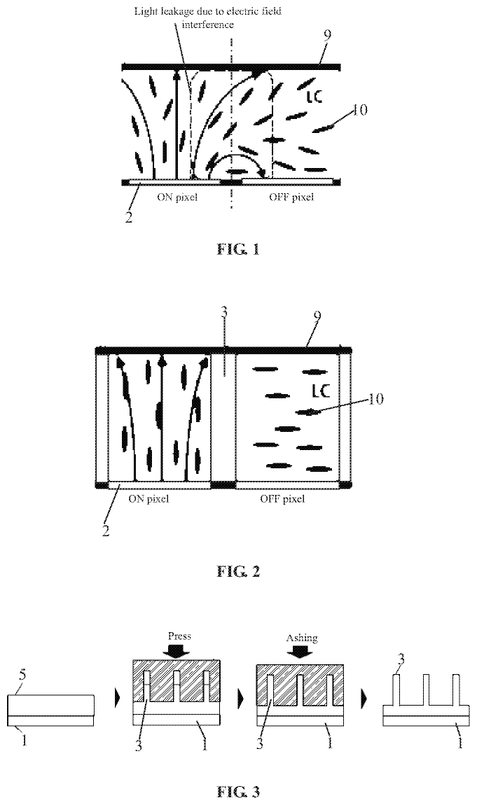

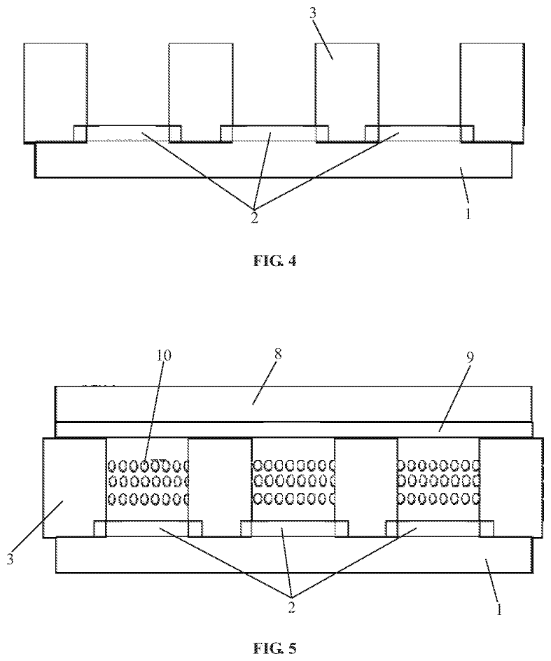

As shown in FIG. 2, when insulating barriers 3 are disposed between the pixels, the phenomenon of display crosstalk caused by mutual interference of electric fields generated between the pixels can be avoided. As shown in FIGS. 3 to 5, in a case where the insulating barriers 3 are formed by a nano-imprint lithography process, the nano-imprint lithography process for forming the insulating barriers 3 must have a capability of accurate alignment with high resolution, otherwise, the formed insulating barriers 3 may overlap with an edge of a pixel, which may cause a loss of the display aperture ratio of the display. For example, referring to FIGS. 4 and 5, the insulating barriers 3 partially overlap the pixel electrodes 2, so that in a liquid crystal cell formed by aligning the array substrate of FIG. 4 and an upper substrate 8, liquid crystal 10 is between a common electrode 9 and a portion of the pixel electrode 2 that does not overlap with the insulating barrier 3, resulting in a reduction in the aperture ratio of the display.

In one aspect, an embodiment of the present disclosure provides a method for fabricating an array substrate, including: forming a plurality of light-shielding electrode structures spaced apart from each other on a substrate; forming an insulating film on a side of the substrate close to the light-shielding electrode structures, the insulating film covering the plurality of light-shielding electrode structures and the substrate; and forming insulating barriers between adjacent light-shielding electrode structures by performing exposure from a side of the substrate away from the light-shielding electrode structures.

According to the method for fabricating the array substrate, the insulating barriers are formed by performing exposure from the back of the substrate, so that the insulating barrier and an edge of the pixel electrode can be prevented from being overlapped, and the display aperture ratio is not lost; through the light-shielding electrode structure, the insulating barriers 3 can be normally formed by back exposure, thereby avoiding the phenomenon of display crosstalk caused by mutual interference of electric fields generated between adjacent pixels and improving the quality of the array substrate.

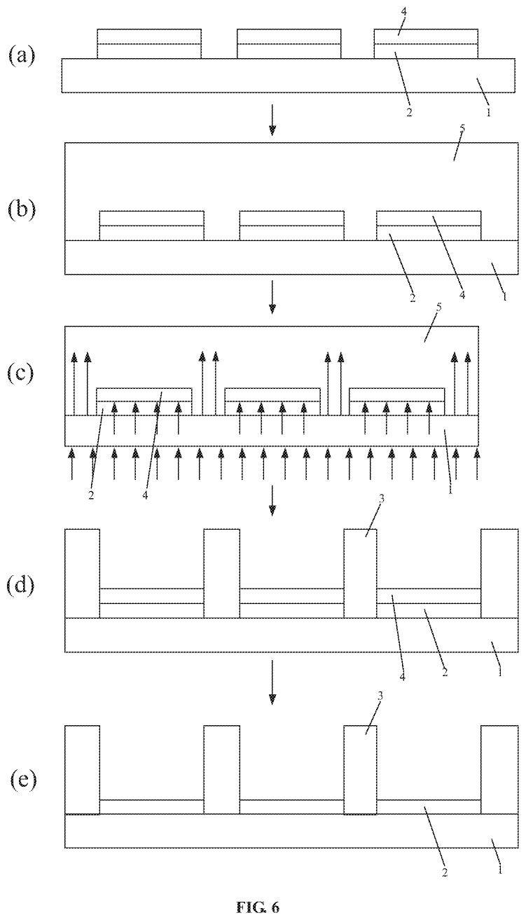

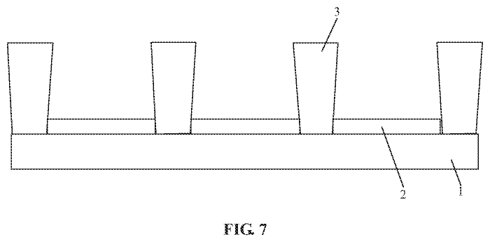

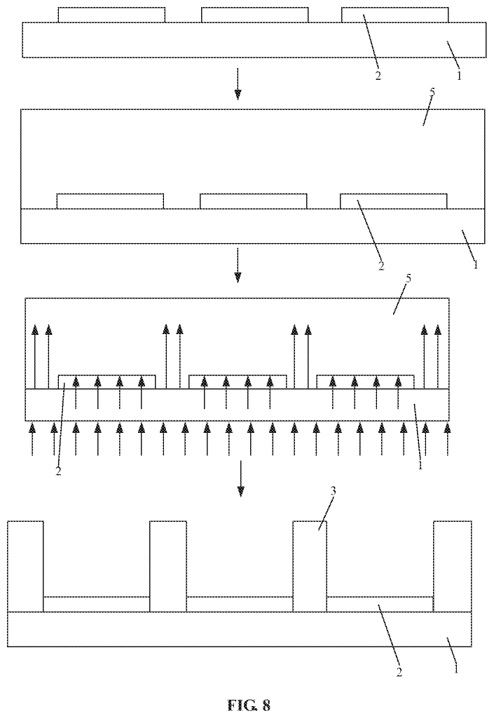

In some embodiments, referring to FIG. 6, the light-shielding electrode structure includes a light-transmissive pixel electrode 2 and a light-shielding pattern 4, and an orthogonal projection of the light-shielding pattern 4 on the substrate 1 completely coincides with an orthogonal projection of the pixel electrode 2 on the substrate 1. In this case, as shown in FIG. 6(b), an insulating film 5 is formed on a side of the substrate 1 close to the pixel electrode 2 and the light-shielding pattern 4, and the insulating film 5 covers the pixel electrode 2, the light-shielding pattern 4 and the substrate 1. Then, as shown in FIG. 6(c), insulating barriers 3 are formed by performing exposure from a side of the substrate 1 away from the pixel electrode 2 and the light-shielding pattern 4.

In some embodiments, the light-shielding pattern 4 and the pixel electrode 2 are simultaneously formed, as shown in FIG. 6(a).

In some embodiments, the light-transmissive pixel electrode 2 is formed before the light-shielding pattern 4 is formed.

By forming the pixel electrode 2 whose orthographic projection on the substrate 1 completely coinciding with the orthographic projection of the light-shielding pattern 4 on the substrate 1, it ensures that the insulating barriers 3 can be normally formed in the case of the light-transmissive pixel electrode 2, thereby avoiding the phenomenon of display crosstalk caused by mutual interference of electric fields generated between adjacent pixels and improving the quality of the array substrate.

In some embodiments, referring to FIG. 6(e), after the insulating barriers 3 are formed, the light-shielding patterns 4 are removed. After the light-shielding patterns 4 are removed, it ensures that light from a backlight can normally transmit through the pixel electrode 2 for display. In the liquid crystal display panel, light from the backlight passes through the pixel electrodes 2 and is deflected by liquid crystal under the action of an electric field to realize image display.

In some embodiments, the light-shielding pattern 4 is made of a light-shielding metal material. For example, the light-shielding pattern 4 is made of metal such as aluminum, copper, or molybdenum.

In some embodiments, the insulating barriers 3 are made of brominated polystyrene or a photoresist material such as black photoresist, other dark colored photoresist, or the like. In this case, the insulating barriers 3 are formed by exposure and development processes. Specifically, referring to FIG. 6(b) to FIG. 6(d), an insulating film 5 is applied on the substrate 1 on which the light-shielding pattern 4 has been formed, the insulating film 5 being made of negative brominated polystyrene or photoresist; after exposing the insulating film 5 from the side of the substrate 1 away from the light-shielding pattern 4 and the pixel electrode 2, a portion of the insulating film 5 shielded by the light-shielding pattern 4 is not exposed, and a portion of the insulating film 5 not shielded by the light-shielding pattern 4 is exposed; after the development, the unexposed portion of the insulating film 5 shielded by the light-shielding pattern 4 is removed, and the exposed portion of the insulating film 5 not shielded by the light-shielding pattern 4 remains, thereby forming the insulating barriers 3 between the pixel electrodes 2.

In some embodiments, the light-transmissive pixel electrode includes crystalline indium tin oxide, and the forming of the light-transmissive pixel electrode 2 includes: depositing a pixel electrode film of amorphous indium tin oxide on the substrate 1; patterning the pixel electrode film by, for example, an exposure process to form pixel electrodes spaced apart from each other; and annealing the pixel electrodes to convert the amorphous indium tin oxide into crystalline indium tin oxide.

The amorphous indium tin oxide material is converted into the crystalline indium tin oxide material through annealing, so that the pixel electrode 2 is not easily damaged by etching in the subsequent wet etching process for removing the light-shielding pattern 4.

In addition, in the fabrication of the array substrate, other structures such as a driving circuit need to be formed on the substrate, and the methods for fabricating the other structures are all conventional processes, which are not described herein.

Based on the above fabrication method of the array substrate, an embodiment of the present disclosure further provides an array substrate fabricated by the method. As shown in FIG. 7, the array substrate includes a substrate 1, and pixel electrodes 2 and insulating barriers 3 disposed on the substrate 1, where the pixel electrodes 2 are arranged in an array, and the insulating barriers 3 are disposed in a gap region between adjacent pixel electrodes 2.

In the array substrate, the insulating barriers 3 do not overlap with the edge part of the pixel electrodes 2, so that the display aperture ratio can be ensured not to be lost, the pattern of the insulating barrier 3 is good, the phenomenon of display crosstalk caused by mutual interference of electric fields generated between adjacent pixels can be avoided, and the quality of the array substrate is improved.

In some embodiments, a pitch of the adjacent pixel electrodes 2 is less than 1 μm. Therefore, PPI of the array substrate can be improved.

In some embodiments, a distance between the substrate 1 and a surface of the insulating barrier 3 away from the substrate 1 is greater than a distance between the substrate 1 and a surface of the pixel electrode 2 away from the substrate 1. In other words, the height of the insulating barrier 3 in a direction perpendicular to the substrate 1 is greater than the height of the pixel electrode 2 in the direction. That is, the insulating barrier 3 has a certain height, so that the phenomenon of display crosstalk caused by mutual interference of electric fields generated between adjacent pixels can be better avoided, and the quality of the array substrate is improved.

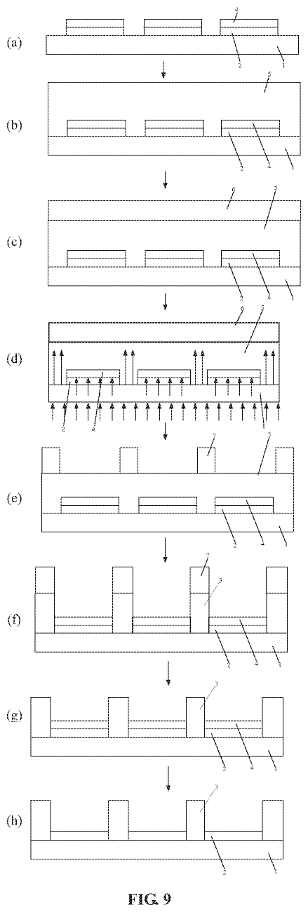

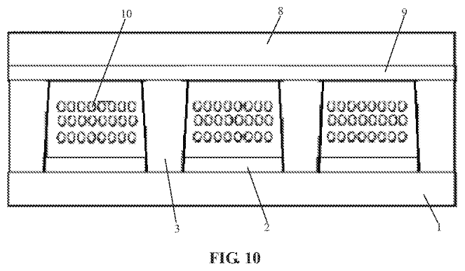

In the embodiment of the present disclosure, a cross section of the insulating barrier 3 taken along a plane perpendicular to the substrate 1 has a shape of inverted trapezoid. For example, referring to FIGS. 7 and 10, the length of an upper edge of the section of the insulating barrier 3 taken along the plane perpendicular to the substrate 1 (i.e., the edge of the section away from the substrate 1) is greater than the length of a lower edge (i.e., the edge of the section close to the substrate 1). The shape of the section of the insulating barrier 3 is determined by the back exposure process. Since the exposure light is diffracted at the edge of the light shielding electrode structure during the back exposure, the insulating barrier 3 is finally formed to have an inverted trapezoidal section. It should be noted that, the shape of the insulating barrier 3 in FIG. 6 (and subsequent FIGS. 8 and 9) for illustrating the fabrication steps is only for the convenience and clarity of drawing, and does not mean that a cross section of the insulating barrier 3 formed by the method according to the embodiments of the present disclosure can have a rectangular shape.

In addition, other structures in the array substrate are the same as the conventional structures, and are not described herein.

In some embodiments, referring to FIG. 8, the light-shielding electrode structure includes an opaque pixel electrode 2 with no additional light-shielding pattern.

In this case, the insulating barriers 3 may be formed through the blocking of the exposure light by the pixel electrode 2, and the opaque pixel electrode 2 is not removed after the insulating barriers 3 are formed. Other steps and processes of the method for fabricating an array substrate in this embodiment are the same as those of the embodiment described above with reference to FIG. 6, and are not repeated herein. In this case, a display function is realized by reflection of light by the pixel electrode 2.

In some embodiments, the pixel electrode 2 is made of a light-shielding metal material, such as aluminum, copper, molybdenum, or the like.

Based on the method for fabricating the array substrate, an embodiment of the present disclosure further provides an array substrate fabricated by the method, and the difference of the array substrate from the array substrate in the above embodiment(s) is that the pixel electrode 2 is made of a light-shielding material.

In some embodiments, unlike the case where the insulating barrier 3 is formed of brominated polystyrene or a photoresist material as described above, the insulating barrier 3 is made of silicon nitride or silicon oxide. In this case, the insulating barrier 3 of silicon nitride or silicon oxide is formed by exposure, development, and dry etching processes. Specifically, referring to FIG. 9, an insulating film 5 (see FIG. 9(b)) is formed by chemical vapor deposition on the substrate 1 (see FIG. 9(a)) on which the light-shielding electrode structure has been formed, and a photoresist 6 is applied on the insulating film 5 (see FIG. 9(c)); the back exposure is performed on the photoresist 6 from a side of the substrate 1 away from the light-shielding electrode structure, and the exposed photoresist 6 is developed to form a photoresist pattern 7 (see FIG. 9(d) and FIG. 9(e)); the insulating film 5 is etched by using the photoresist pattern 7 as an etching mask to remove a portion of the insulating film 5 not shielded by the photoresist pattern 7, thereby forming insulating barriers 3 (see FIG. 9(f)); and the photoresist pattern 7 is removed (see FIG. 9(g)). In the case where the light-shielding electrode structure includes the light-transmissive pixel electrode 2 and the light-shielding pattern 4, after the photoresist pattern 7 is removed, the light-shielding pattern 4 may also be removed by etching, as shown in FIG. 9(h).

Based on the method for fabricating the array substrate, an embodiment of the present disclosure further provides an array substrate fabricated by the method, and the difference of the array substrate from the array substrate in the above embodiment(s) is that the insulating barrier 3 is made of silicon nitride or silicon oxide.

In the method for fabricating the array substrate according to the embodiment of the present disclosure, the insulating barriers are formed by performing exposure from the side of the substrate away from the pixel electrode, so that the insulating barrier and the edge of the pixel electrode can be prevented from being overlapped, and the display aperture ratio is not lost; by forming the light-shielding electrode structure before formation of the insulating barriers, the insulating barriers can be normally formed by back exposure, thereby avoiding the phenomenon of display crosstalk caused by mutual interference of electric fields generated between adjacent pixels and improving the quality of the array substrate.

In another aspect, an embodiment of the present disclosure provides a display device, including any one of the array substrates described above.

As shown in FIG. 10, the display device further includes an upper substrate 8 aligned with and arranged opposite to the array substrate, a common electrode 9 disposed on the upper substrate 8, and liquid crystal 10 filled within a gap between the upper substrate 8 and the array substrate.

By adopting the array substrate in the embodiment, the display aperture ratio of the display device is not lost with high-resolution display, the phenomenon of display crosstalk caused by mutual interference of electric fields generated between adjacent pixels can be avoided, and the quality of the display device is improved.

The display device according to the present disclosure may be any product or component with display function, such as an LCD television, a mobile phone, a navigator or the like.

It can be understood that the foregoing embodiments are merely exemplary embodiments used for describing the principle of the present disclosure, but the present disclosure is not limited thereto. Those of ordinary skill in the art may make various variations and improvements without departing from the spirit and essence of the present disclosure, and these variations and improvements shall also fall into the protection scope of the present disclosure.

What is claimed is:

1. A method for fabricating an array substrate, comprising steps of:
forming a plurality of light-shielding electrode structures spaced apart from each other on a substrate;
forming an insulating film on a side of the substrate close to the light-shielding electrode structures, the insulating film covering the plurality of light-shielding electrode structures and the substrate; and
forming insulating barriers between adjacent light-shielding electrode structures by performing exposure from a side of the substrate away from the light-shielding electrode structures.

2. The method of claim 1, wherein each of the light-shielding electrode structures comprises a light-transmissive pixel electrode and a light-shielding pattern, and an orthographic projection of the light-shielding pattern on the substrate completely coincides with an orthographic projection of the pixel electrode on the substrate.

3. The method of claim 2, further comprising: after the step of forming the insulating barriers, removing the light-shielding pattern.

4. The method of claim 2, wherein the light-shielding pattern and the pixel electrode are formed simultaneously.

5. The method of claim 1, wherein each of the light-shielding electrode structures comprises a pixel electrode that is opaque to light.

6. The method of claim 2, wherein the light-shielding pattern is made of a light-shielding metal material.

7. The method of claim 1, wherein the insulating film comprises brominated polystyrene or a photoresist, and
wherein the step of forming the insulating barriers comprises:
exposing the insulating film from the side of the substrate away from the light-shielding electrode structures, and
developing the exposed insulating film to form the insulating barriers.

8. The method of claim 1, wherein the insulating film comprises silicon nitride or silicon oxide, and
wherein the step of forming the insulating barriers comprises:
forming a photoresist layer on a side of the insulating film away from the substrate;
exposing the photoresist layer from the side of the substrate away from the light-shielding electrode structures;
developing the exposed photoresist layer to form a photoresist pattern; and
etching the insulating film by using the photoresist pattern as an etching mask to form the insulating barriers.

9. The method of claim 2, wherein the light-transmissive pixel electrode comprises crystalline indium tin oxide,
wherein the step of forming the plurality of light-shielding electrode structures comprises forming the light-transmissive pixel electrode of each of the light-shielding electrode structures, and
wherein the forming of the light-transmissive pixel electrode of each of the light-shielding electrode structures comprises:
forming a pixel electrode film of amorphous indium tin oxide on the substrate by deposition,
patterning the pixel electrode film to form the pixel electrodes spaced apart from each other, and
annealing the pixel electrodes to convert the amorphous indium tin oxide into the crystalline indium tin oxide.

10. The method of claim 6, wherein the light-shielding pattern is made of any one of aluminum, copper, or molybdenum.

11. An array substrate, the array substrate being fabricated by the method of claim 1, the array substrate comprising:
a substrate; and
pixel electrodes and insulating barriers on the substrate, the pixel electrodes being spaced apart from each other, the insulating barriers each being between adjacent ones of the pixel electrodes.

12. The array substrate of claim 11, wherein a pitch of the adjacent pixel electrodes is less than 1 μm.

13. The array substrate of claim 11, wherein a distance between the substrate and a surface of each of the insulating barriers away from the substrate is greater than a distance between the substrate and a surface of each of the pixel electrodes away from the substrate.

14. The array substrate of claim 11, wherein a cross section of each of the insulating barriers taken along a plane perpendicular to the substrate has a shape of inverted trapezoid.

15. A display device, comprising the array substrate of claim 11.

16. An array substrate, comprising:
a substrate; and
pixel electrodes and insulating barriers on the substrate, the pixel electrodes being spaced apart from each other, the insulating barriers each being between adjacent ones of the pixel electrodes,
wherein a cross section of each of the insulating barriers taken along a plane perpendicular to the substrate has a shape of inverted trapezoid.
